(19) United States
(12) Patent Application Publication
(10) Pub. No.: US 2017/0042336 A1
(43) Pub. Date: Feb. 16, 2017

(54) Ready-to-Assemble Bed Foundation Kit with Threaded Pin Assembly

(71) Applicant: Larry J. Craver, Winston-Salem, NC (US)

(72) Inventor: Larry J. Craver, Winston-Salem, NC (US)

(21) Appl. No.: 15/233,431

(22) Filed: Aug. 10, 2016

Related U.S. Application Data
(60) Provisional application No. 62/203,602, filed on Aug. 11, 2015.

(51) Int. Cl. A47C 19/00; A47B 88/04; A47C 23/00; F16B 12/14; A47C 19/02; A47C 19/22

(52) U.S. Cl. CPC A47C 19/005; A47C 19/025; A47C 19/22; A47C 23/005; F16B 12/14; A47B 88/04; F16B 2012/145

(57) ABSTRACT

A ready-to-assemble bed foundation includes a pair of exterior side beams having two ends and a pair of transverse end beams having two ends. The beams can be assembled on site into a rectangular or square frame by joining one end of each side beam with one end of a transverse end beam. A drawer can be positioned between upper and lower surfaces. A protruding block on one beam is sized to fit into a gap between plates for registration of the beam to which it is being joined. At least one of the plates has a hole and the protruding block has an embedded threaded pin receiver positioned to align with the hole in the plate when a corner configuration is formed by the beams. A threaded pin passes through the hole and into the threaded pin receiver to retain the beams in a corner configuration. A single layer assembly can also employ fasteners at each corner.

### CROSS REFERENCE TO PRIOR CO-PENDING APPLICATION

This application claims the benefit of prior co-pending U.S. Provisional Patent Application 62/203,602 filed Aug. 11, 2015.

### BACKGROUND OF THE INVENTION

The disclosure is directed to a ready-to-assemble or knock down (KD) bed foundation. More specifically, the bed foundation includes a pair of exterior side beams connectable to a pair of transverse end beams having openings. The foundation also includes an interior beam between the side beams having opposing end portions configured to engage the openings in the transverse end beams.

Ready-to-assemble bed foundations are known. Many are expensive and difficult to assemble, while others are of the type having a solid panel immediately below a mattress or box spring. These panels are often bulky or otherwise not suited to cost-effective shipping and storage. Other prior art foundations prevent access to the area below the mattress for storage, or do not provide for the addition of a slipcover. Thus, the prior art has not adequately addressed the need for a ready-to-assembly bed foundation that is economical to manufacture and easy to assemble, provides a comfortable yet stable support, permits access to a storage area under the bed, and provides for the addition of a slipcover.

Ready-to-assemble bed foundations are known, such as U.S. Patent Publication 2008/0208709 of Craver, and U.S. Pat. No. 8,990,979 of Craver. Such foundations use molded plastic interior connectors for holding side and end beams together. However, the cost of the molded connectors drives up the overall cost of the foundation, so it would be beneficial to have a lower cost way to connect the beams together.

### SUMMARY OF THE INVENTION

A ready-to-assemble bed foundation includes a pair of exterior side beams having two ends and a pair of transverse end beams having two ends. The beams have adaptions to enable them to be assembled into a rectangular or square frame by joining one end of each side beam with one end of a transverse end beam. The adaptations include a protruding block on one beam sized to fit into a gap between plates of the beam to which it is being joined. At least one of the plates has a hole and the protruding block has an embedded threaded pin receiver positioned to align with the hole in the plate when a corner configuration is formed by the beams. A threaded pin passes through the hole and into the threaded pin receiver to retain the beams in a corner configuration.

Conveniently, all four corners may have the same adaptations. The beam with the protruding block can be the side beam or the transverse end beam. The beam having the gap between plates is the other beam at that corner.

Slats are commonly included to span between side beams. The side beams may have slots on top of the side beams to receive the slats and Christmas tree fasteners to join the slats in the slots on the side beams.

A slipcover may be included for placement over the foundation. A collapsible mattress may be included. Typically, slats are included that can be installed to span the exterior beams as assembled.

### BRIEF DESCRIPTION OF THE DRAWINGS

The invention will be better understood by those skilled in the art after a reading of the following description of the preferred embodiment when considered with the drawings in which:

FIG. 1 is a top perspective view of an embodiment of an assembled frame for a ready-to-assemble foundation for a bed.

FIG. 2 is an enlarged top perspective view of fastening system for joining slats to the foundation.

FIG. 3 is a side perspective view of the outside of a corner of an embodiment of the ready-to-assemble foundation.

FIG. 4 is a top perspective view of a joint between an interior beam and a transverse end beam of an embodiment of a ready-to-assemble foundation for a bed.

FIG. 5 is a top perspective view of a slipcover on the ready-to-assemble bed foundation.

FIG. 6 is a top perspective view of a mattress suitable for use with embodiments of the foundation in a mattress container.

FIG. 7 is a top perspective view of an embodiment of a bed foundation having an optional slipcover and a mattress atop the foundation and slipcover.

FIG. 8 is a perspective view of an unassembled corner.

FIG. 9 is a perspective view of a receiver for a threaded pin.

FIG. 10 is a perspective view of a threaded pin to use with the receiver of FIG. 9.

FIG. 11A is a three dimensional view shown from the top of an alternate embodiment in which the ready to assemble bed foundation receives drawers able to be inserted into opposite sides.

FIG. 11B is a three dimensional view shown from the bottom of an alternate embodiment in which the ready to assemble bed foundation receives drawers able to be inserted into opposite sides.

FIGS. 12A and 12B are exploded views of a drawer assembly that can be shipped in a generally flat configuration and can be assembled on site and can be inserted into a companion space in the ready assembly bed frame shown in FIGS. 11A and 11B. FIG. 12A shows how the bottom of a drawer is assembled to the sides and rear, while FIG. 12B shows assembly of the drawer front to the subassembly shown in FIG. 12A. The components of the drawers can be shipped flat. FIGS. 12C and 12D show another version of this drawer assembly in which the side are hinged relative to the front and rear so that the sides and the front and rear can be folded into a flat pack or folded configuration for shipment. FIG. 12C is a front view with the interior hinges shown and FIG. 12D is a side view also with the hinges shown in order to depict how the drawer assemble can be folded into a flat pack or collapsed configuration.

FIGS. 13A-13H are views showing another alternate embodiment in which the bed frame is assembled in a single layer so that it can be used as a bed foundation for a single bed, such as a bunk bed and platform beds. FIG. 13A shows the various components of a kit for this single layer bed foundation in an unassembled configuration for shipment and prior to on site assembly. FIG. 13B shows the major components laid out for assembly. FIG. 13C shows one corner of the single layer bed foundation, showing the manner in which one side rail will fit with a single end rail, as well as the fasteners and tool required for connecting the side rail to the end rail. FIG. 13D shows the same corner as in FIG. 13C with one of two male pins inserted to connect the side rail to the end rail and with a second pin aligned for insertion into a second opening a female connector. FIG. 13E shows the use of a tool to tighten the second male pin. FIG. 13F shows the manner in which fasteners are used to attach one end an individual slat to a companion side rail. FIG. 13G shows an assembled corner of the single layer ready to assemble bed foundation, with multiple slats attached to one side rail and with an end rail also extending from the corner at which it is attached to the side rail. FIG. 13H shows a single layer bed foundation in which the frame has been fully assembled, with the cover being fitted over the frame.

### DETAILED DESCRIPTION OF THE PREFERRED EMBODIMENTS

The illustrations and descriptions thereof are for the purpose of describing embodiments of a bed foundation and are not intended to limit the invention to any particular embodiment shown or described. Those of ordinary skill will recognize that the foundation described by the appended claims is subject to numerous embodiments.

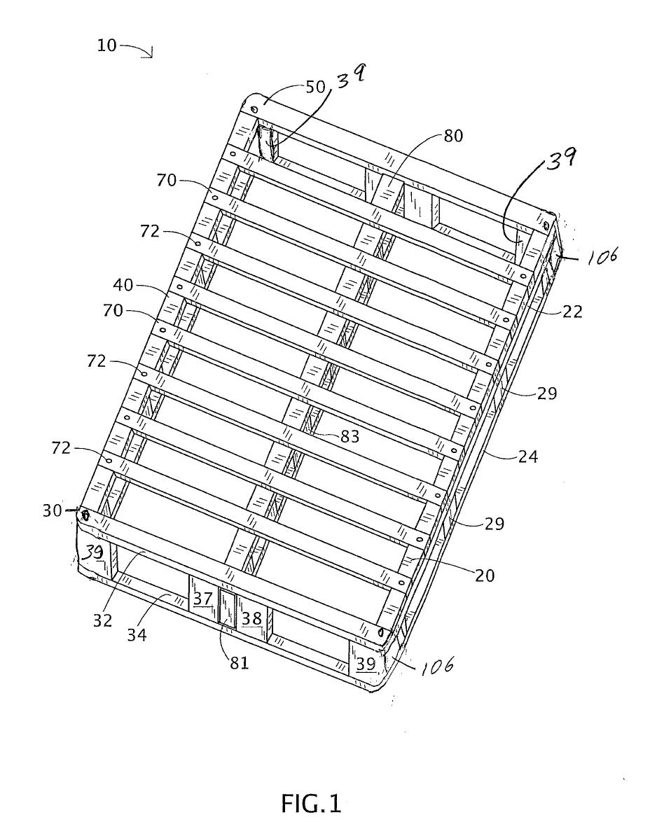

FIG. 1 shows a foundation frame 10 for a bed. It is shown as rectangular, but could be square. The frame 10 includes a pair of exterior side beams 20 and 40 extending longitudinally between a pair of transverse end beams 30 and 50 to form a generally rectangular outer frame. An interior support beam 80 may optionally be centrally located between the beams 20 and 40. Each of a plurality of flexible, spaced apart slats 70 extends longitudinally from one of the exterior side beams 20 or 40 to the interior beam 80 and has a top surface generally coplanar with the top surface of the frame. In the representative embodiment depicted herein, each of the exterior side beams 20 and 40, the interior support beam 80 and the transverse end beams 30 and 50 comprises a multipart subassembly or truss, and the components of these beam subassemblies are cut from wood, such as spruce or pine, so that the structure is economical to fabricate, although other materials can be employed.

The exterior side beam 20 is substantially identical to the beam 40 and includes an upper 22 and lower member 24 spaced vertically by a plurality of blocks 29 between the members 22 and 24. The upper member 22 includes a plurality of spaced apart slots for receiving the slats 70 and provide, with ends of the slats 70, a generally planar top surface for the frame.

The transverse end beam 30 is substantially identical to the beam 50 and includes a pair of longitudinal members 32 and 34 spaced vertically by a plurality of blocks 37, 38 and 39. In the preferred embodiment each of the longitudinal members 32 and 34 can comprise a piece of spruce or pine having a 1 inch by 3 inch cross section, and the blocks 37, 38 and 39 can also be cut from spruce or pine. The blocks 37 and 38 are spaced to provide an opening sized and positioned for receiving an end portion 81 of the interior beam 80. In the embodiment of the foundation 10 shown in FIG. 1, the opening between the blocks 37 and 38 is slightly larger than the end portion 81, which allows the end portion 81 to float within the opening. This allows the interior beam 80 to move slightly while being retained in place. Such movement provides “give” when an occupant of the bed moves. The ends of beams 30 and 50 are curved on their outward sides to give the assembled frame 10 four rounded corners. At least one notch is formed in one of the beams at each corner of the bed foundation frame, to position and register two mating beams at each corner in a rectangular orientation to form a rectangular bed foundation, and to align fasteners in the beams and/or blocks at each corner.

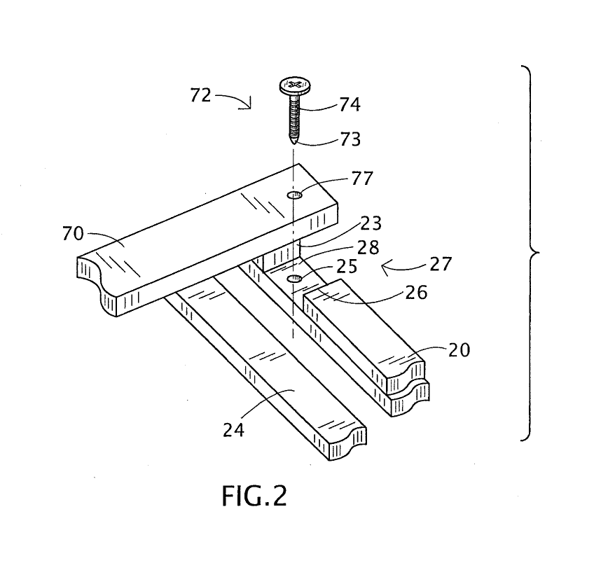

FIG. 2 shows a fastener 72 for repeatedly coupling to and removing the slat 70 from the exterior side beams, which includes a filler strip or slots such as the slot 27 defined by opposing walls 23 and 26 and a substantially horizontal surface 28 between the walls 23 and 26. The slat 70 includes an opening 77 and the surface 28 includes an opening 25 for receiving a fastener 72, which has stem 73 surrounded by a flexible flanges 74. Fasteners 72 are of the type often referred to as “Christmas tree” fasteners. The openings 77 and 25 are sized to provide engagement of the flanges 74 so the fastener 72 holds the slat 70 to the beam 20. The slat remains in place during ordinary use of the foundation, yet the fastener 72 can be removed without the need for special tools. This permits removal of the slat 70 for storage or transportation of the foundation frame. Each slat 70 includes an opening at its opposite end like the opening 77 for receiving an additional fastener 72 and the beam 40 shown in FIG. 1 includes openings such as the opening 77, allowing both ends of the slat to be fastened to its respective side beam.

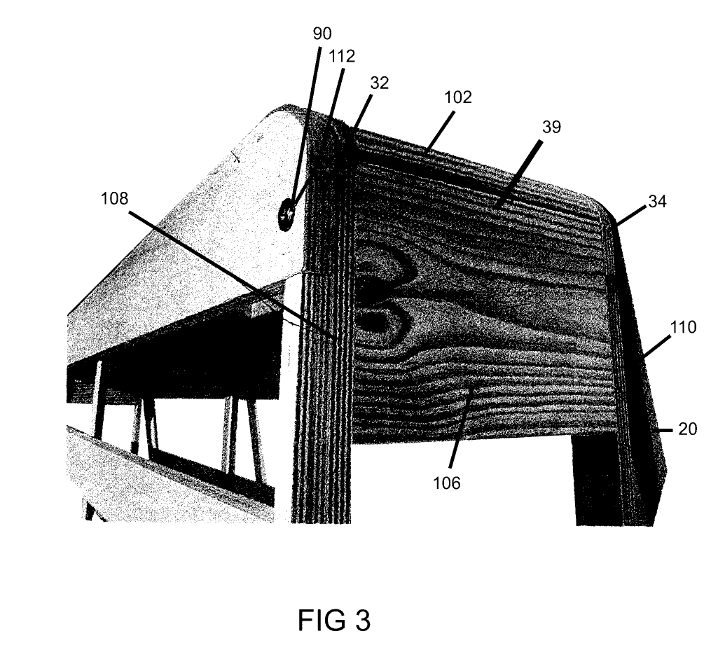

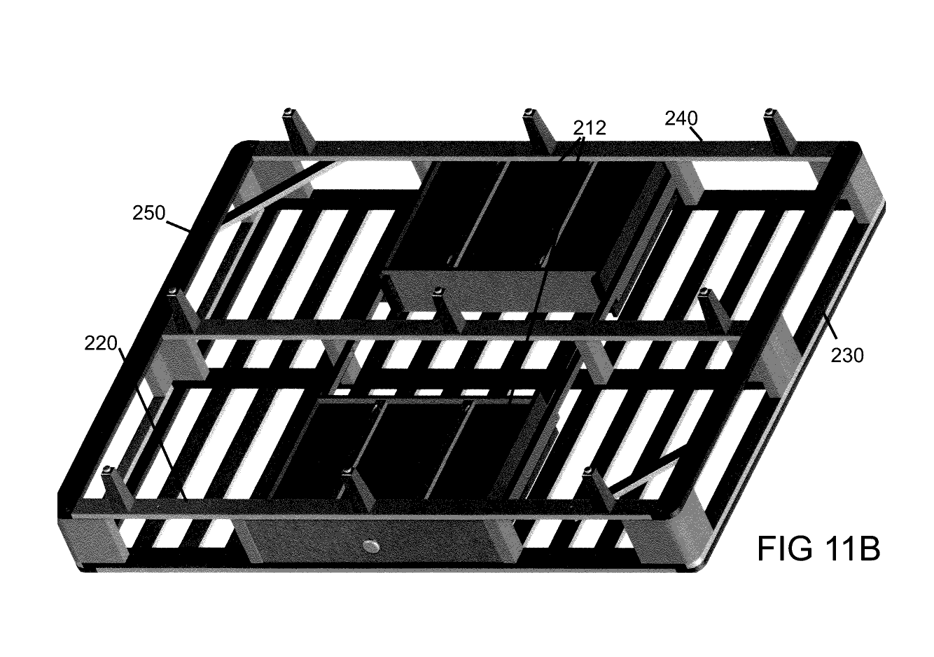

FIG. 3 shows an outside corner of the foundation 10 including a connector 90. The exterior side beam 20 is coupled to the transverse end beams 30 with the connector 90. This structure is replicated at the other corners of the outer frame of the foundation 10. The end beam 30 includes the members 32 and 34, which are spaced apart from one another by block 39, so the interior parts 102, 104 of the members 32 and 34 have a gap between them. That gap is filled during assembly of the frame by the end block 106 of side beam 20. End block 106 and the end of top plate 108 protrude beyond end of bottom plate 110 of the side beam 20. Plate 108, and the bottom of end block 106 have threaded pin receivers at the top and bottom that align with holes or orifices 112 in the members 32 and 34. The pin 120 can be inserted through hole or orifice 112 to engage the embedded threaded pin receiver (see FIGS. 8, 9, and 10) in a corresponding orifice in another member to make the connector 90.

FIG. 8 shows the end beam 30 separated from the side beam 20, so the threaded pin receiver 111 is visible. When assembled, the end of plate 108 is positioned below the member 32. A similar configuration with receiver and pin is provided at the bottom of member 34 and block 106, so screw connections are preferably located top and bottom of the corner of the frame. That structure is preferably replicated at the other three corners of the frame.

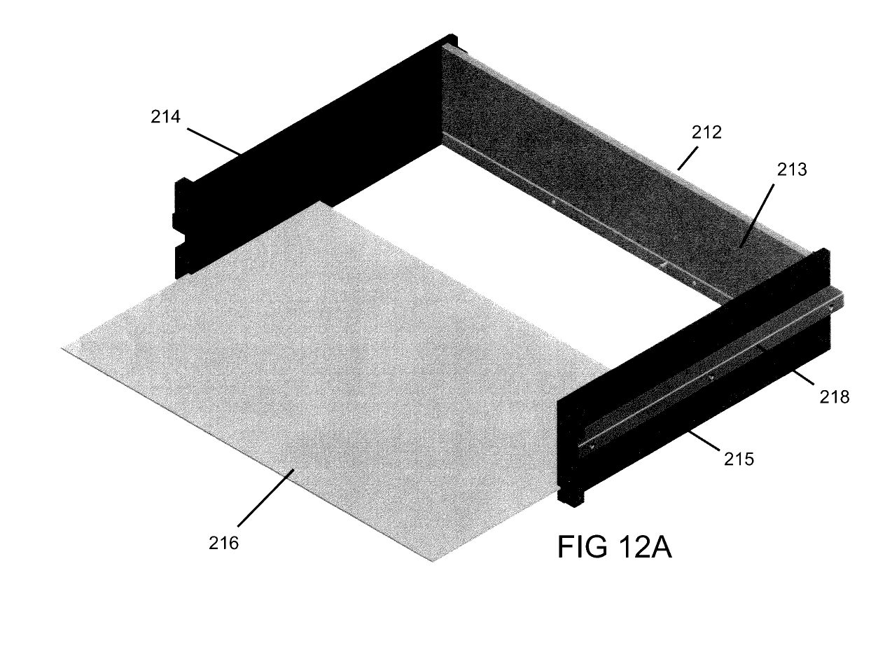

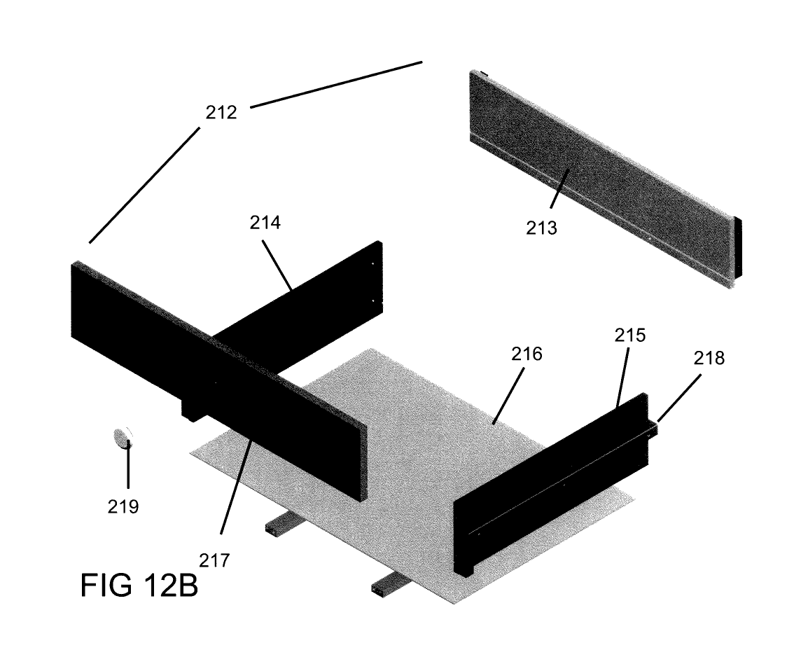

FIGS. 9 and 10 show a threaded pin and receiver for the threaded pin. The receiver can be an insert nut that provides a threaded socket for a wooden workpiece, similar to a wall anchor. Insert nuts are inserted into a pre-drilled hole by one of two means: screw in and hammer in. In both cases, the external protrusions bite into the wood, preventing the nut from either turning or pulling out. Insert nuts can be installed from one side of the workpiece.

The receiver shown in FIG. 9 is a screw-in insert nut. It has an external thread and hex head and are screwed in with an Allen wrench. The pre-drilled hole must be as deep as the length of the insert nut plus any portion of the bolt that may be screwed past the end of the nut in the work piece. The receiver can also be a hammer-in insert nut, also known as a knock-in nut, are lined with barbs and are hammered in. They may be made of steel, brass or nylon, or other material.

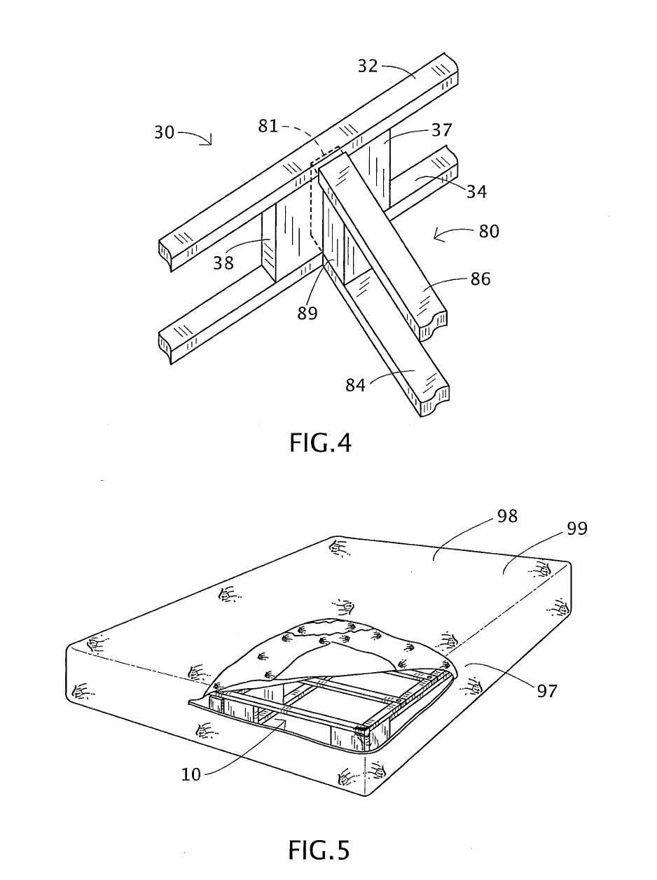

FIG. 4 is view of an end of the interior beam 80, which also includes an upper member 86 and lower member 84 spaced vertically by a plurality of blocks such as the blocks 83 (shown in FIG. 1) and 89. The upper member 86 includes a generally horizontal planar surface for supporting the slats 70 without the need for fastening the slats 70 to the member 86. The beam 80 includes two opposing end blocks or portions, such as the end portion 81 shown, which is configured extend into the opening between the blocks 37 and 38 of the transverse end beam 30 when the foundation is assembled.

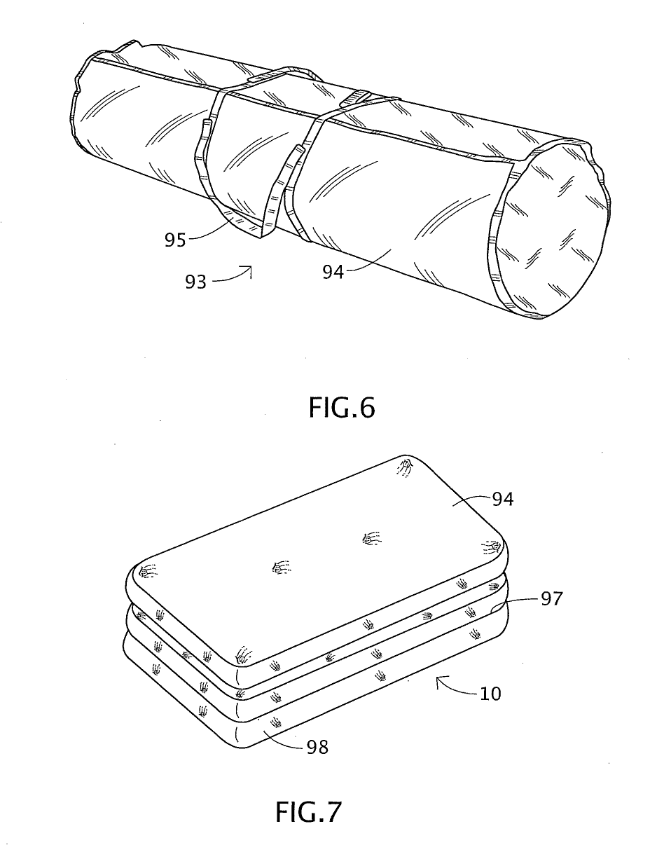

FIG. 5 shows the foundation frame 10 with a slipcover 98 to complete the foundation. The slipcover 98 may optionally include an integrally formed padding 99 for placement above the frame and a zipper seam 97 to facilitate installation of the assembled frame 10 in the slipcover 98.

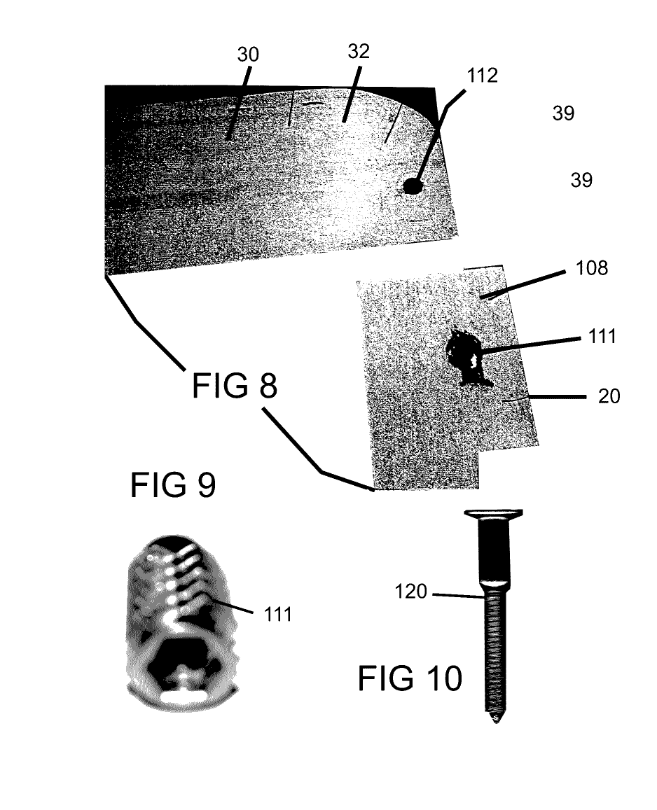

FIG. 6 shows a mattress 94 in a collapsed configuration. The mattress 94 shown is vacuum-packed into a shipping box or carrying bag 93 including handles 95. The disassembled frame 10 can likewise be packaged in a carton, with or without carrying handles, or bag such as the bag 93 shown. The bag 93 provides a convenient container for carrying the mattress 94 and/or bed frame 10 and slipcover 98 from a store to a vehicle, and further for transport from the vehicle into a residence for assembly. Alternatively, the mattress 94 can be sold to a customer from a catalogue or internet site and shipped in this collapsed configuration.

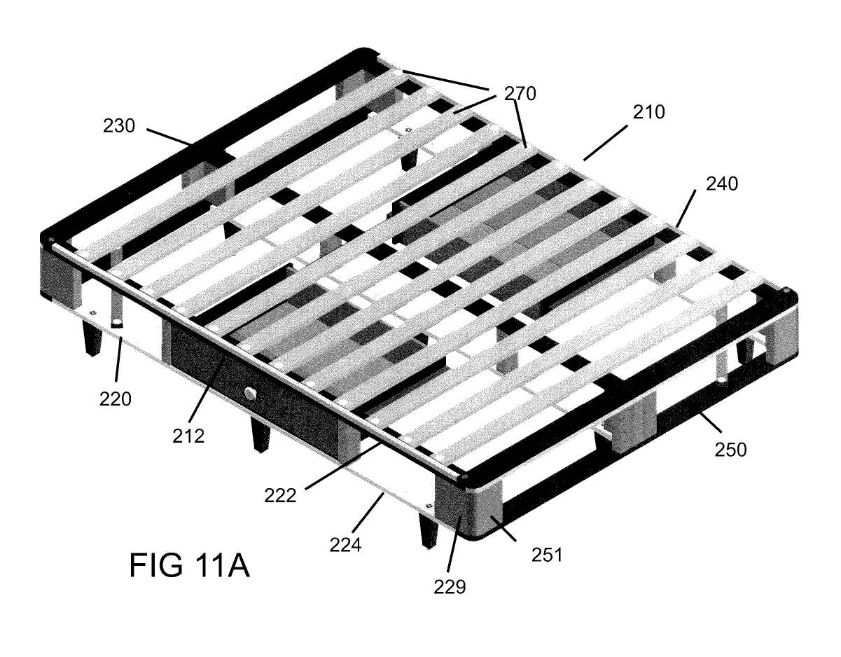

FIG. 7 shows the mattress 94 expanded full size atop the foundation and optional slipcover 98. A consumer can convert the mattress to the full sized configuration shown after transport to a residence by simply removing the mattress 94 from the bag 93 shown in FIG. 5, unrolling it, and removing the vacuum mattress bag cover and allowing it to allow the mattress to expand.

The bed foundation can be provided in various sizes including but not limited to twin, double, queen, king and California king.

While the detailed disclosure shows that the beam with the protruding block is the side beam, it can just as well be the transverse end beam. The beam having the gap between plates is the other beam at that corner. In order to minimize confusion, preferably the adaptations that make the four corners of the frame are all the same, but it is within the scope of the invention to use other corner-joining structures for some corners, but at least one corner has the threaded pin and pin receiver structure as described herein.

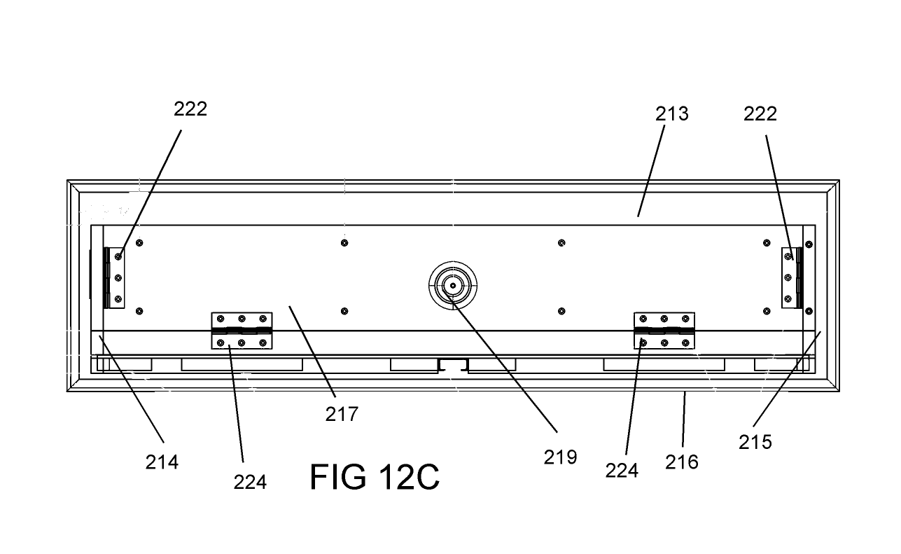

After the frame is assembled, the space between the upper and lower surfaces can be used for storage. FIGS. 11A and 11B are two views of a first alternate embodiment of a ready to assemble bed foundation frame 210, which provides space for two drawers 212 located on either side of the frame 210. As with the bed foundation frame 10, this alternated bed foundation 210 can be shipped flat and assembled on site. The supporting structure of side beam subassemblies 220 and 240 can provide a drawer opening, sufficient for receipt of a drawer 212, without compromising the load carrying capacity of the frame 210. One drawer 212 can slide between the upper and lower rails or wooden boards 222 and 224. The drawers 212 would be positioned below the slats 270. A similar construction could be employed in the opposite side beam assembly 240. As in the first embodiment, the side beam subassemblies 220 and 240 are supported by blocks at the corners where they are joined to the transverse or head and foot beam subassemblies 230 and 250. Two blocks 229 and 251, which engage each other are shown at one intersection corner where side beam subassembly 220 joins transverse beam subassembly 250. In this alternated embodiment the two blocks 229 and 251 abut at right angles, and one or more horizontal pins and receptacle fasteners can be employed to connect the sides and the head and foot of the frame 210. Alternatively the overlapping configuration and the vertical pin orientation of FIGS. 1-8 can be employed in a frame assembly including drawers of the type shown in FIGS. 11A and 11B.

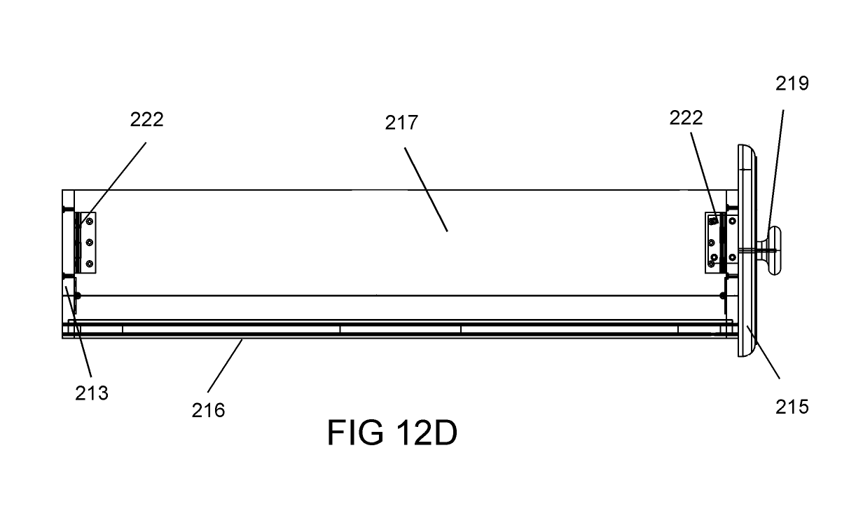

FIGS. 12A and 12B show a drawer configuration that can be shipped flat and assembled on site, at the same time that the frame 210 is assembled. Each drawer 212 includes a rear panel 213 and two side panels 214 and 215, which can be assembled to a bottom panel 216. Although not shown, supports can be screwed or attached on the outer side of bottom panel 216, and the bottom panel 216 can be attached to the back panel 213 using wood dowels to slide the bottom panel 216 into place and then securing the panels with fasteners, such as screws. FIG. 12B shows a front panel 217 which can be attached to the previously assembled panels, again using wood dowels to align the parts and screws or other fasteners to secure all of the panels together. A drawer pull 219 can be attached to the exterior of the front panel 217. Of course the drawer opening must remain accessible and would not be covered by a slip cover as shown in the embodiment of FIG. 1-6. A covering, such as upholstered panels can be secured to the side beam subassemblies 220 and 240 on either side of the drawer opening. This covering could be attached either prior to shipment of on site. Cooperating guides can also be mounted in the frame and on the drawers for each of movement of the drawers. The opening for a drawer can extend from any peripheral surface including the head and foot of the bed foundation or the side thereof.

Another embodiment of the drawer subassembly is shown in FIGS. 12C and 12D. In this view the side panels 214 and 215 are hinged relative to the front and rear panels 213 and 217 so that the sides may be folded inwardly about hinges 222, and then the front and rear panels 213 and 214 can be folded parallel to the bottom panel 216 about hinges 224. The entire drawer subassembly is then in a flat pack or collapsed configuration for shipment. In the embodiment shown in FIGS. 12C and 12D, one of the hinges 222 is located between one of the side panels and the rear panel 213. The other side panel is hinged relative to the front panel 217 so that one hinge 222 is located at the front of the drawer subassembly and the other hinge 222 is located at the rear thereof. Thus each side panel 214, 215 folds as one piece.

In still another embodiment the side panels 214 and 215 are each formed as two separate sections, and the rear of side panels 214 and 215 are hinged on both sides to rear panel, while the front sections of side panels 214 and 215 are joined by two hinges 222 to the front panel 217 so that panel sections on each side can fold towards both the front and rear to further reduce the size of the flat pack. Locks or latches (not shown) are provided on the edges of the rear panel or on the side panel sections to lock or latch the side panels in place when in the fully assembled configuration.

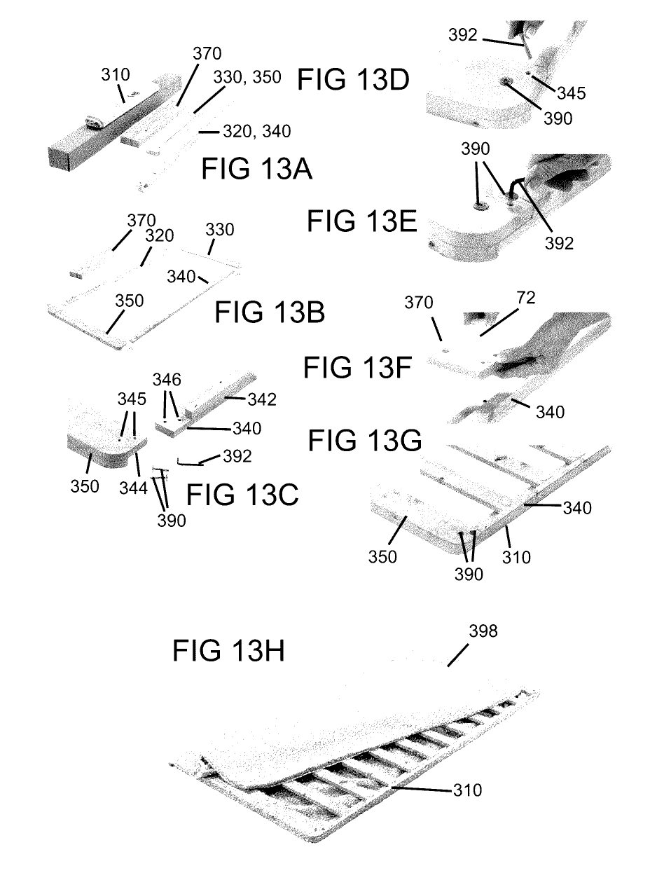

Although not providing space for drawers as in FIGS. 11A, 11B, 12A and 12B, an alternate embodiment of this invention can be employed with a single layer frame, such as frame 310, shown in FIGS. 13A-13H. This single layer bed foundation frame assembly 310 can be used in various application, such as for example to replace a bulky and inconvenient to ship plywood board of the type used for beds, such as bunk beds or other sized beds. This third embodiment also provides a more economical configuration that will be easier for many users to assemble on site. The ready to assemble bed foundation assembly 310 can be shipped as parts of a ready to assemble kit, including two side rails 320 and 340, two transverse or head and foot rails 350 and 330, slats 310, as well as a slip cover, all of which can be packaged in box for easy shipment. This embodiment does not use trusses or multi part side and transverse beam assemblies. Only single wooden beams, 320, 340, 330 and 350 will be employed. As shown in FIG. 13B, these individual beams can be laid in a rectangular configuration for on site assembly. Although generally flat, the side beams 320 and 340 do include a longitudinally extending rib, such as rib 342 shown in FIG. 13C, to which the slats can be attached as well as providing an abutting surface, when the side rails 320, 340 are attached to transverse end rails 330, 350 during on site assembly. As shown in FIG. 13C a tongue or thinner section is formed by the primary flat beam 340 extending beyond the rib 342. A notch 344 is formed on the cooperating end beam 350 so that the upper section of the end beam will overlap the side beam end when these to perpendicular beams are assembled. Each corner can employ the same structure. Pins 390 can be inserted through holes 345 extending through the notched end of the end beam 350, and pins 390 will be inserted through holes into engagement with a female fastener, not shown, to secure the beams at the corners. The male and female fasteners employed in this embodiment can be the same as those shown in FIGS. 9 and 10. A simple tool, such as an Allen wrench 390 can be employed. Thus portions of the beams at each corner will overlap, in much the same fashion as for the embodiment of FIGS. 1-8. After assembly of the frame 310 is completed, a cover 298 can be applied. One additional difference, however, is that two sets of fasteners are used at each corner in the embodiment of FIGS. 13A-13H. These fasteners 390, and the holes 345 through which they extend upon assembly are aligned at an angle relative to both of the perpendicular sides of the completed bed foundation assembly. By employing two fasteners in this orientation at each corner, any tendency of the beams to rack or deviate from the assembled perpendicular configuration during use, will be reduced or eliminated. This multi-fastener configuration is not limited to a single lay ready to assembly bed foundation as shown in FIGS. 12A-13H, and can be employed in a modified version of the ready to assembly bed foundation 10 shown in FIGS. 1-8.

One modification of the bed foundation subassembly shown in FIGS. 13A-13H involves the provision for a center member or beam extending from the head to the foot to support the slats. A metallic tubular member (not shown) can be employed for this purpose. One means of fabricating such a member would involve flattening opposite ends of this tubular member and forming the ends upwardly so that the tubular member will extend beneath the slats 370 and support the slats and well as provide further rigidity for the single layer bed foundation. Holes may be punched adjacent the distal ends of tubular member in the flattened sections for receipt of a screw or other fastener to attach the tubular member to the opposite transverse rails 330 and 350 at the head and foot of the single layer bed foundation.

The ready-to-assemble bed foundations are formed for a kit so that the bed foundation can be assembled from components of the kit on site by a series of assembly steps and the bed foundation can be disassembled on site by reversing the series of assembly steps. Certain modifications and improvements will occur to those skilled in the art upon a reading of the foregoing description. For instance, wood members are preferred for most of the components of the various embodiments depicted herein, but other materials could be employed. All such modifications and improvements have not been included herein but may properly fall within the scope of the appended claims.

I claim:

1. A ready-to-assemble bed foundation comprising:
a pair of exterior side beams having two ends, a pair of transverse end beams having two ends, the beams having adaptions to enable them to be assembled into a rectangular or square frame by joining one end of each side beam with one end of a transverse end beam,
the adaptations for at least one corner comprising a protruding block on one beam sized to fit into a gap between plates of the beam to which it is being joined, at least one of the plates having a hole, the protruding block having an embedded threaded pin receiver positioned to align with the hole in the plate when a corner configuration is formed by the beams, and a threaded pin to pass through the hole in the plate and be threaded into the treaded pin receiver to retain the beams in a corner configuration.

2. A ready-to-assemble bed foundation as claimed in claim 1 wherein all four corners have the same adaptations.

3. A ready-to-assemble bed foundation as claimed in claim 1 the beam with the protruding block is a side beam.

4. A ready-to-assemble bed foundation as claimed in claim 1 wherein the beam having the gap between plates is a transverse end beam.

5. A ready-to-assemble bed foundation as claimed in claim 1 comprising slats to span between side beams.

6. A ready-to-assemble bed foundation as claimed in claim 5 wherein the side beams have slots on top of the side beams to receive the slats and further comprising Christmas tree fasteners to join the slats in the slots on the side beams.

7. The ready-to-assemble bed foundation according to claim 1 further including a slipcover for placement over the foundation.

8. The ready-to-assemble bed foundation according to claim 1 further including a collapsible mattress.

9. The ready-to-assemble bed foundation according to claim 1 further including slats that can be installed to span the exterior beams as assembled.

10. The ready to assembly bed foundation according to claim 1 wherein a drawer is located in an opening in at least one of the side beams.

11. A ready-to-assemble bed foundation kit for fabricating a bed foundation, the kit comprising:
a pair of exterior side beams having two ends and a pair of transverse end beams having two ends, notches on one corner of at least one beam at a corner where each side beams engages one of the transverse end beams to form mating beams, so that the beams can be aligned when one of the mating beams fits into the notch in the other mating beam, and the pairs of beams can be assembled into a rectangular frame by joining one end of each side beam with one end of a transverse end beam at each corner;
each of the beams having an orifice at each corner, the notches aligning orifices in two mating beams at each corner; and
at least one pin insertable into the aligned orifices at each end to assemble the beams in a rectangular frame, the pins also being disengagable so that the bed foundation formed by components of the kit can be assembled and disassembled by reversing the sequence of fabricating the bed frame.

12. The ready-to-assemble bed foundation kit of claim 11 wherein a male pin is insertable through and orifice in one mating beam at each corner, and a female fastener is positioned in the alignable orifice in the other mating beam at each corner.

13. The ready-to-assemble bed foundation kit of claim 11 wherein one of the orifices at each corner extends through one of the beams in which the one orifice is located and the other orifice extends only partly through the other beam at each corner.

14. The ready-to-assemble bed foundation kit of claim 11 wherein a pair of aligned orifices are located at each corner, the two orifices in each pair being positioned in a line extending at an angle relative to the beams positioned in the rectangular frame, so that pairs of pins at each corner will resist racking of the beams forming the rectangular frame.

15. The ready-to-assemble bed foundation kit of claim 14 wherein the rectangular frame is formed by a single layer of side beams and end beams.

16. The ready-to-assemble bed foundation kit of claim 11 wherein the pins and the orifices extend vertically when the bed foundation is in a horizontal configuration.

17. The ready-to-assemble bed foundation kit of claim 11 wherein each side beam and each end beam comprises a multipart beam subassembly comprising upper and lower rails with blocks positioned between the upper and lower rails in each beam to form load bearing beam truss subassemblies, with a block at each corner and with at least one of the orifices extending at least partially into each corner block at each corner.

18. The ready-to-assemble bed foundation kit of claim 11 wherein all load bearing members other than fasteners are formed of wood and exhibit the rigidity of wood.

19. A ready-to-assembly bed foundation kit for use in fabricating a rectangular bed foundation to support a mattress positionable on the bed foundation, components of the bed foundation kit being attachable on site by a series of assembly steps and detachable on site by reversing the series of assembly steps; the bed foundation kit comprising:
a pair of side beam trusses and a pair of transverse end beam trusses, one side beam truss being attachable to and detachable from one of the end beam trusses at each corner of the rectangular bed foundation during assembly, each side beam truss and each end beam truss comprising upper and lower rails with block extending between and permanently attached between each upper and lower rail in the corresponding truss with at least one block being located at each corner of the bed foundation upon attachment of the trusses to each other, side beam trusses being registrable with end beam trusses at each corner to align fasteners for attachment into the rectangular bed foundation;
blocks located between corners of at least one of the beams forming an drawer opening extending inwardly from a peripheral edge; and
a drawer insertable into the drawer opening into a space between upper and lower surfaces of the bed foundation.

20. The ready-to-assemble bed foundation kit of claim 19 wherein the fasteners include a male pin and a female pin extending into orifices at each corner of the bed foundation for attaching side beam trusses to end beam trusses.
